(19) United States
(12) Patent Application Publication
(10) Pub. No.: US 2026/0321132 A1
(43) Pub. Date: Oct. 15, 2026

(54) Control Device for Autonomous Vehicle, Program, Signal Control Device, Traffic Signal Device, Traffic Signal System, Signal Control Program, Information Notification Device, and Information Notification Program

(71) Applicant: SoftBank Group Corp., Tokyo (JP)

(72) Inventor: Masayoshi Son, Minata-ku-Tokyo (JP)

(21) Appl. No.: 19/120,064

(22) PCT Filed: Oct. 3, 2023
(86) PCT No.: PCT/JP2023/036092

§ 371 Date: Apr. 10, 2025

(30) Foreign Application Priority Data
Oct. 14, 2022 (JP) 2022-165875
Oct. 27, 2022 (JP) 2022-172347
Mar. 9, 2023 (JP) 2023-036942
Mar. 15, 2023 (JP) 2023-041210

(51) Int. Cl. G08G 1/07; B60W 30/18; B60W 50/00; B60W 50/14; B60W 60/00; G08G 1/01; G08G 1/0967

(52) U.S. Cl. CPC G08G 1/07; B60W 30/18159; B60W 50/14; B60W 60/001; G08G 1/0116; G08G 1/096725; G08G 1/096783; B60W 2050/0028; B60W 2050/146; B60W 2552/10; B60W 2556/45

(57) ABSTRACT

A control device that controls a vehicle includes an information acquisition unit that acquires a plurality of pieces of information detected by a sensor installed in a traffic signal, and a control unit that controls the vehicle using the plurality of pieces of information acquired by the information acquisition unit and a trained model.

### TECHNICAL FIELD

The present disclosure relates to a control device for an autonomous vehicle, a program, a signal control device, a traffic signal device, a traffic signal system, a signal control program, an information notification device, and an information notification program.

### BACKGROUND ART

Patent Literature 1 discloses a vehicle having an autonomous driving function.

### PRIOR ART DOCUMENT

### Patent Literature

Patent Literature 1: Japanese Patent Application Laid-Open No. 2022-035198

### SUMMARY OF INVENTION

### Solution to Problem

According to an aspect of the present disclosure, provided is a control device that controls a vehicle, the control device including an information acquisition unit that acquires a plurality of pieces of information detected by a sensor installed in a traffic signal, and a control unit that controls the vehicle using the plurality of pieces of information acquired by the information acquisition unit and a trained model. The control unit may control the vehicle every billionth of a second using the plurality of pieces of information and the trained model.

The control unit may control the vehicle using the plurality of pieces of information detected by the sensor installed in the traffic signal and the trained model in a case where the vehicle enters an intersection at which the traffic signal is installed, and control the vehicle using a plurality of pieces of information detected by a sensor mounted on the vehicle and the trained model in a case where the vehicle travels a travel path other than the intersection.

The control unit may control the vehicle using the plurality of pieces of information detected by the sensor installed in the traffic signal and the trained model in a case where the vehicle enters the intersection and in a case where an output value of the trained model in a case where the plurality of pieces of information detected by the sensor installed in the traffic signal is input to the trained model matches an output value of the trained model in a case where the plurality of pieces of information detected by the sensor mounted on the vehicle is input to the trained model.

According to an aspect of the present disclosure, provided is a program for causing a computer to function as the information acquisition unit and the control unit.

According to an aspect of the present disclosure, a signal control device is provided. The signal control device includes a first acquisition unit that acquires a traffic condition around an intersection from a sensor provided around the intersection, a second acquisition unit that acquires a travel plan of an autonomous vehicle scheduled to pass through the intersection, a determination unit that determines whether or not a delay in the travel plan of the autonomous vehicle occurs when the autonomous vehicle passes through the intersection on the basis of the traffic condition acquired by the first acquisition unit, and a control unit that controls a traffic signal at the intersection so as to suppress the delay in a case where the determination unit determines that the delay occurs.

In this aspect, on the basis of the traffic condition around the intersection acquired from the sensor provided around the intersection, it is determined whether or not the delay in the travel plan of the autonomous vehicle occurs when the autonomous vehicle scheduled to pass through the intersection passes through the intersection. In this aspect, in a case where it is determined that the delay in the travel plan of the autonomous vehicle occurs, the traffic signal at the intersection is controlled so that the delay in the travel plan of the autonomous vehicle is suppressed. As a result, it is possible to suppress occurrence of the delay in the travel plan of the autonomous vehicle, and it is possible to suppress application of a large load such as re-creation of the travel plan to an in-vehicle computer that performs autonomous driving control and the like during travel.

In a case where the determination unit determines that the delay occurs, the control unit may control the traffic signal at the intersection such that the traffic signal at the intersection is maintained to be a green light while the autonomous vehicle passes through the intersection.

In this aspect, control of the traffic signal at the intersection so as to suppress the delay in the travel plan of the autonomous vehicle is implemented by maintaining the traffic signal at the intersection to be a green light while the autonomous vehicle passes through the intersection. As a result, it is possible to suppress the time in which the traffic signal at the intersection is on the green light from becoming longer than necessary while ensuring the safety when the autonomous vehicle passes through the intersection as compared with the case of performing control such as increasing the time in which the traffic signal at the intersection is on the green light for a certain period of time.

The autonomous vehicle in which the control unit controls the traffic signal at the intersection so as to suppress the delay may be the autonomous vehicle having a degree of urgency set in advance equal to or higher than a predetermined value.

According to this aspect, it is possible to suppress occurrence of the delay in the travel plan for the autonomous vehicle having the degree of urgency equal to or higher than a predetermined value, and since the number of times of controlling the traffic signal at the intersection is suppressed, it is also possible to suppress the number of other vehicles other than the autonomous vehicle having the degree of urgency equal to or higher than the predetermined value of which travel might be affected along with the control of the traffic signal at the intersection.

The signal control device may further include a cooperative control unit that controls each of traffic signals at a plurality of intersections through which the autonomous vehicle is scheduled to sequentially pass so that the delay is suppressed in a case where the determination unit determines that the delay occurs.

In this aspect, in a case where it is determined that the travel plan of the autonomous vehicle is delayed, each of the traffic signals at the plurality of intersections through which the autonomous vehicle is scheduled to sequentially pass is controlled, so that the delay in the travel plan of the autonomous vehicle can be eliminated while the autonomous vehicle sequentially passes through the plurality of intersections.

According to an aspect of the present disclosure, a traffic signal device is provided. The traffic signal device includes the signal control device and the traffic signal, and is provided at each intersection.

In this aspect, since the signal control device is included, it is possible to suppress occurrence of a delay in the travel plan of the autonomous vehicle.

According to an aspect of the present disclosure, a traffic signal device is provided. The traffic signal system includes the traffic signal device provided at each of a plurality of intersections, and a cooperative control device that controls each of traffic signals at the plurality of intersections through which the autonomous vehicle is scheduled to sequentially pass so that the delay is suppressed in a case where the determination unit of any of a plurality of traffic signal devices determines that the delay occurs.

In this aspect, since the cooperative control device is included, it is possible to eliminate the delay in the travel plan of the autonomous vehicle while the autonomous vehicle sequentially passes through the plurality of intersections.

According to an aspect of the present disclosure, a signal control program is provided. The signal control program causes a computer to execute processing including acquiring a traffic condition around an intersection from a sensor provided around the intersection, and acquiring a travel plan of an autonomous vehicle scheduled to pass through the intersection, determining whether or not a delay in the travel plan of the autonomous vehicle occurs when the autonomous vehicle passes through the intersection on the basis of the acquired traffic condition, and controlling a traffic signal at the intersection so as to suppress the delay in the case of determining that the delay occurs.

According to this aspect, it is possible to suppress occurrence of the delay in the travel plan of the autonomous vehicle.

According to an aspect of the present disclosure, an information notification device is provided. The information notification device includes an acquisition unit that acquires a traffic condition around an intersection from a sensor provided around the intersection, a generation unit that generates notification information to an autonomous vehicle about to enter the intersection on the basis of the traffic condition acquired by the acquisition unit, and a display control unit that displays the notification information generated by the generation unit on a display unit provided around the intersection as code information.

In this aspect, the traffic condition around the intersection is acquired from the sensor provided around the intersection, and the notification information to the autonomous vehicle about to enter the intersection is generated on the basis of the acquired traffic condition around the intersection. The generated notification information is displayed on the display unit provided around the intersection as the code information. As a result, the autonomous vehicle can acquire the notification information by capturing an image of the display unit on which the code information is displayed and decoding the code information included in the captured image. In this manner, in this aspect, since the autonomous vehicle can be notified of the notification information without using a mobile communication network, the autonomous vehicle can be notified of the information without being affected by a communication status of the mobile communication network.

The generation unit may generate, as the notification information, information including travel instruction information for instructing each of a plurality of autonomous vehicles about to enter the intersection to travel.

In this aspect, the notification information includes a plurality of pieces of travel instruction information instructing each of the plurality of autonomous vehicles about to enter the intersection to travel, and the notification information is displayed as code information on the display unit. As a result, by displaying single notification information as the code information on the display unit, it is possible to give a travel instruction to each of the plurality of autonomous vehicles about to enter the intersection.

The generation unit may generate the travel instruction information in consideration of a traffic condition in a blind spot region that is a blind spot from the autonomous vehicle around the intersection.

In this aspect, when the travel instruction information is generated, the traffic condition in the blind spot region that is the blind spot from the autonomous vehicle around the intersection is considered. As a result, it is possible to give a travel instruction in consideration of the traffic condition in the blind spot region that is the blind spot from the autonomous vehicle to the autonomous vehicle.

The display control unit may display a two-dimensional barcode on the display unit as the code information.

In this aspect, since the two-dimensional code is displayed on the display unit as the code information, it is possible to increase an information amount of the notification information that can be displayed as the code information on the display unit, as compared with an aspect in which a one-dimensional code is displayed as the code information.

According to an aspect of the present disclosure, a traffic signal device is provided. The traffic signal device includes the information notification device and the traffic signal, and is provided at each intersection.

In this aspect, since the information notification device is included, the autonomous vehicle can be notified of the information without being affected by a communication status of the mobile communication network.

According to an aspect of the present disclosure, an information notification device is provided. The information notification program causes a computer to execute processing including acquiring a traffic condition around an intersection from a sensor provided around the intersection, generating notification information to an autonomous vehicle about to enter the intersection on the basis of the acquired traffic condition, and displaying the generated notification information on a display unit provided around the intersection as code information.

According to this aspect, the autonomous vehicle can be notified of the information without being affected by a communication status of the mobile communication network.

The summary of the disclosure described above does not enumerate all the necessary features of the present disclosure. A subcombination of this feature group may also be the disclosure.

### BRIEF DESCRIPTION OF DRAWINGS

FIG. 1 schematically illustrates hazard prediction capability of AI in ultra-high performance autonomous driving.

FIG. 2 schematically illustrates a central brain in the ultra-high performance autonomous driving.

FIG. 3 is a diagram for describing a blind spot of a vehicle.

FIG. 4 is a diagram for describing a sensor installed in a traffic signal.

FIG. 5 schematically illustrates perfect speed control.

FIG. 6 schematically illustrates perfect bell curves.

FIG. 7 is a schematic diagram of perfect cruising.

FIG. 8 is a schematic diagram of perfect cruising.

FIG. 9 is a schematic diagram of perfect cruising.

FIG. 10 is a schematic diagram of perfect cruising.

FIG. 11 is a schematic diagram of perfect cruising.

FIG. 12 is a schematic diagram of perfect cruising.

FIG. 13 is a schematic diagram of perfect cruising.

FIG. 14 is a block diagram illustrating an example of a functional configuration of the central brain.

FIG. 15 is a diagram for describing a trained model.

FIG. 16 is a flowchart illustrating an example of a processing routine executed by the central brain.

FIG. 17 is a block diagram schematically illustrating an example of a hardware configuration of a computer functioning as a control device.

FIG. 18 is a block diagram illustrating a schematic configuration of a signal control system according to a second embodiment.

FIG. 19 is a flowchart illustrating an example of signal control processing.

FIG. 20 is a timing chart for describing an effect of the signal control processing.

FIG. 21 is a flowchart illustrating another example of the signal control processing.

FIG. 22 is a block diagram illustrating a schematic configuration of an information notification system according to a third embodiment.

FIG. 23 is a front view illustrating a traffic signal and a display unit according to the third embodiment.

FIG. 24 is a plane view illustrating arrangement of the traffic signal and the display unit according to the third embodiment.

FIG. 25 is a flowchart illustrating an example of information notification processing.

### DESCRIPTION OF EMBODIMENTS

Hereinafter, the present disclosure will be described through disclosed embodiments, but the following embodiments do not limit the disclosure according to claims. Not all combinations of features described in the embodiments are essential for the disclosed solutions.

### First Embodiment

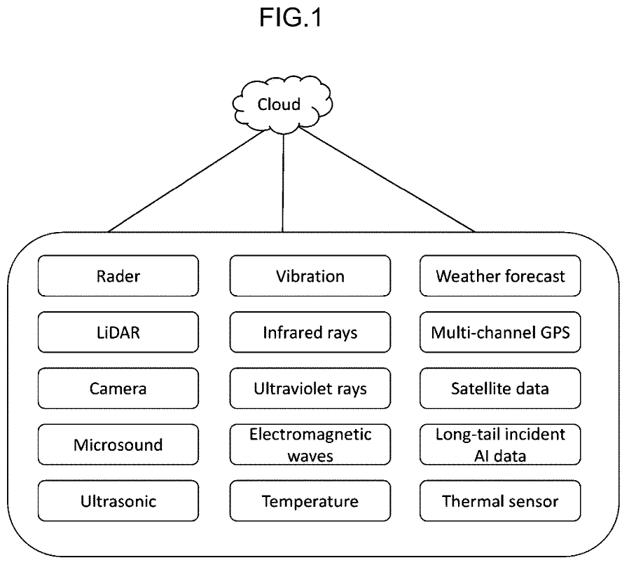

FIG. 1 schematically illustrates hazard prediction capability of AI in ultra-high performance autonomous driving according to the present embodiment. In the present embodiment, a plurality of types of sensor information is converted into AI data and accumulated in a cloud. The AI predicts and determines a best mix of situations every nanosecond and optimizes an operation of a vehicle.

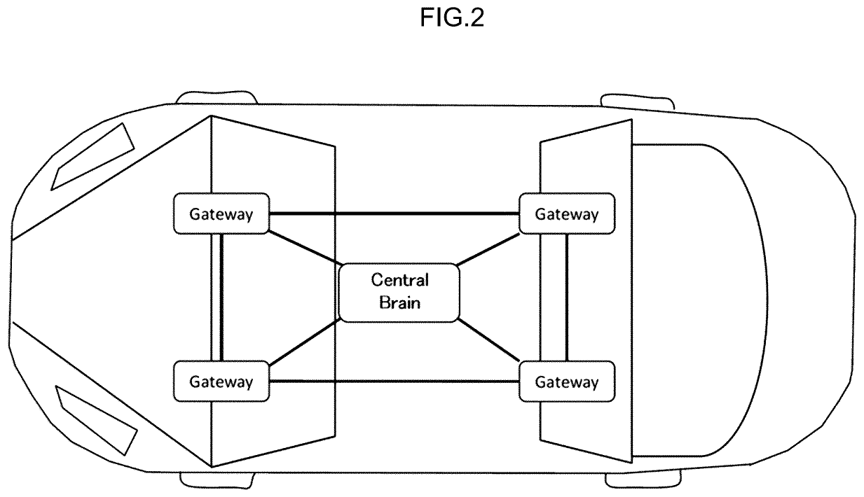

FIG. 2 schematically illustrates a central brain in the ultra-high performance autonomous driving according to the present embodiment. The central brain is an example of a control device that controls a level 6 autonomous vehicle.

The level 6 is a level representing autonomous driving, and corresponds to a level higher than a level 5 representing fully autonomous driving. The level 5 represents fully autonomous driving, but this is an equivalent level to manned-driving, and there still is a probability of occurrence of an accident or the like. The level 6 is a level higher than the level 5, and corresponds to a level at which a probability of occurrence of an accident is lower than that at the level 5.

Examples of a sensor mounted on a vehicle in the present embodiment include a radar, a LiDAR, a high-pixel, telephoto, ultra-wide-angle, 360-degree, high-performance camera, vision recognition, microsound, an ultrasonic wave, vibration, infrared rays, ultraviolet rays, electromagnetic waves, temperature, humidity, a spot AI weather forecast, a high-accuracy multi-channel GPS, low-altitude satellite information, long-tail incident AI data or the like. The long-tail incident AI data is trip data of a level 5 automobile.

Examples of sensor information to be taken in from a plurality of types of sensors include gravity center movement of a body weight, road material detection, outside air temperature detection, outside air humidity detection, detection of an inclination angle in vertical, lateral, and oblique directions of a slope, a freezing manner of a road, moisture content detection, a material, a wear status, and air pressure detection of each tire, a road width, whether or not overtaking is prohibited, vehicle type information of an oncoming vehicle and front and rear vehicles, cruising states of these vehicles, a surrounding situation (bird, animal, soccer ball, accident vehicle, earthquake, housework, wind, typhoon, heavy rain, light rain, snowstorm, fog or the like) or the like. In the present embodiment, these detections are performed every nanosecond.

In the present embodiment, the central brain may execute matching with a weather forecast having a highest accuracy rate for each minimum spot by an entire road+AI from these pieces of information. The central brain may execute matching with position information of another vehicle from these pieces of information. The central brain may execute matching (matching of a remaining level and a speed for every nanosecond on the path) with a best estimated vehicle type from these pieces of information. The central brain may execute matching with a mood of music or the like to which a passenger is listening from these pieces of information. The central brain may execute instantaneous condition rearrangement in which desired feeling is changed from these pieces of information.

The central brain may upload AI data to the cloud when charging the vehicle, for example. A data lake may be formed and the AI may analyze and always upload to a latest state.

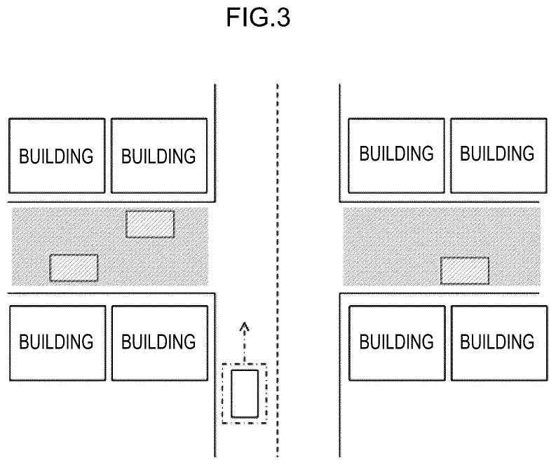

As illustrated in FIG. 3, the sensor mounted on the vehicle can detect an object such as another vehicle even at a long distance on a straight line in a travel direction, but there is a blind spot region where the sensor cannot detect an object at an intersection or the like. In an example of FIG. 3, a solid line rectangle surrounded by a dot-and-dash line rectangle represents the vehicle equipped with the sensor, and a dot-and-dash arrow represents a travel direction of the vehicle. A hatched region represents the blind spot region where the sensor mounted on the vehicle cannot detect the object.

In this case, there is a risk of a traffic accident due to presence of the blind spot region for the vehicle.

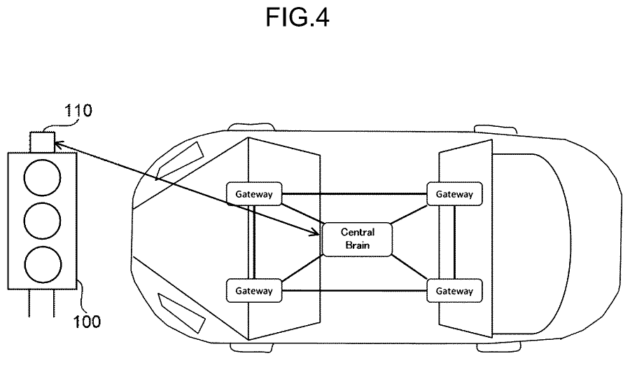

Therefore, as illustrated in FIG. 4, in the present embodiment, a sensor 110 capable of communicating with the central brain of the level 6 autonomous vehicle is installed in all traffic signals 100 in town. Examples of the sensor 110 include the radar, LiDAR, and high-pixel, telephoto, ultra-wide-angle, 360-degree, high-performance digital camera or the like. In the example of FIG. 4, the sensor 110 is installed in an upper part of the traffic signal 100, but an installation place of the sensor 110 is not limited to the upper part of the traffic signal 100. The sensor 110 may be installed on a side surface of the traffic signal 100, or may be installed on a pillar of the traffic signal 100.

In each traffic signal 100, information detected in the blind spot region for the autonomous vehicle is collected by the sensor 110, and road condition information is transmitted to the level 6 autonomous vehicle by wireless communication.

The central brain acquires a plurality of pieces of information detected by the sensor 110 installed in the traffic signal 100, and controls the vehicle using the acquired plurality of pieces of information and AI.

The central brain may use both software and hardware as a method of optimizing vehicle passage. In terms of software, the central brain implements best mix of all of the plurality of pieces of information detected by the sensor 110 installed in the traffic signal 100, information accumulated in the cloud, and the sensor information of the vehicle by the AI, and the AI determines every nanosecond, thereby implementing autonomous driving that meets a demand of the passenger. In terms of hardware, the vehicle performs microcontrol of a rotary output of a motor every billionth of a second (nanosecond). The vehicle includes electricity and a motor capable of communicating and controlling in nanosecond. According to the central brain, since the AI predicts a crisis, brake is not required, and perfect stop can be performed without spilling water in a cup. Power consumption is low, and brake friction does not occur.

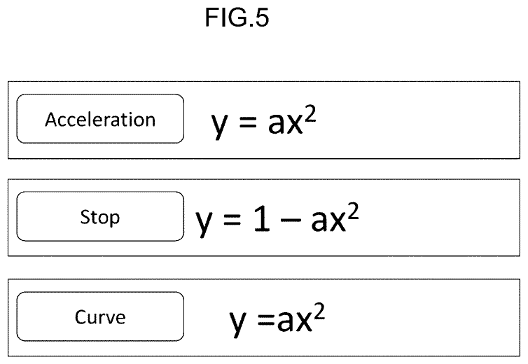

FIG. 5 schematically illustrates perfect speed control implemented by control by the central brain according to the present embodiment. A principle illustrated in FIG. 5 serves as an index for calculating a braking distance of the vehicle, and it is controlled by this basic equation. In a system according to the present embodiment, since there is ultra-high performance input data, calculation can be performed with a fine bell curve.

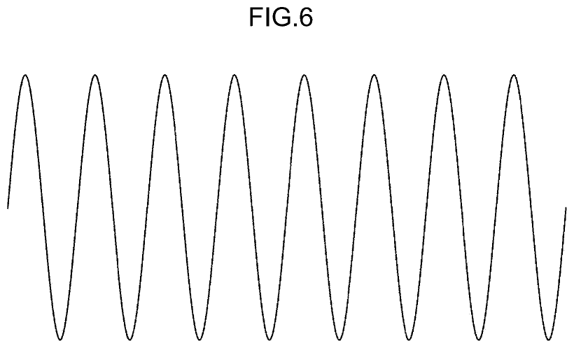

FIG. 6 schematically illustrates perfect bell curves implemented by the control by the central brain according to the present embodiment.

The ultra-high performance autonomous driving can be implemented at an arithmetic speed of one million TOPS.

As described above, in the present embodiment, the central brain may implement the perfect cruise control. The central brain may execute control according to a request of an occupant in the vehicle. Examples of the request of the occupant include the “shortest time”, the “longest battery remaining level”, “desire to avoid carsickness the most”, “desire to feel G (safely) the most”, “desire to feel a landscape by mixture of the above or the like the most”, “desire to feel a landscape different from a previous one”, “desire to follow memories of the road visited with someone a few years ago, for example”, “desire to avoid a probability of an accident the most” or the like, and other various conditions are discussed with the passenger by the central brain, and the central brain executes perfect mix with the vehicle by the number of passengers, weight, position, and gravity center movement of a body weight (calculation for every nanosecond), road material detection for every nanosecond, outside air temperature detection for every nanosecond, outside air humidity detection for every nanosecond, and selection of the above-described total conditions for every nanosecond.

The central brain may consider and execute an “inclination angle in vertical, lateral, and oblique directions of a slope”, “matching with a weather forecast having the highest accuracy rate of an entire path+every minimum spot by the AI”, “matching with position information of another vehicle for every nanosecond”, “matching of them with the best estimated vehicle type (matching of remaining level and speed for every nanosecond on the path)”, “matching with a mood of music or the like to which the passenger is listening”, “instantaneous condition rearrangement with changed desired feeling”, “estimation of an optimal mix of a freezing manner of a road for every nanosecond, moisture content, wear of material of each tire of four, two, eight, 16 tires or the like, an air pressure, and the rest of the road”, “lane width and angle of the road for every time, and whether overtaking is prohibited in the lane”, “types of vehicles on an oncoming lane and front and rear lanes and a cruising state of the vehicle (for every nanosecond)”, and “best mix of all other conditions)”.

A position to be taken is not the center but different positions in each lane in a lane width. This is different depending on the speed, angle, and road information at that time. For example, matching of inference of the best probability of influence of a flying bird, an animal, an oncoming vehicle, a flying soccer ball, a child, an accident vehicle, earthquake, fire, wind, typhoon, heavy rain, light rain, snowstorm, fog, and others for every nanosecond is executed.

Perfect matching is executed using capability of a version of the central brain at that time and most recently updated information of the brain cloud accumulated by that time.

This may be defined as perfect cruising of ultra-high performance autonomous driving. Therefore, the ultra-high performance autonomous driving requires power management of a battery in which one million TOPS is the best at that time and an AI synchronized burst chilling function of temperature.

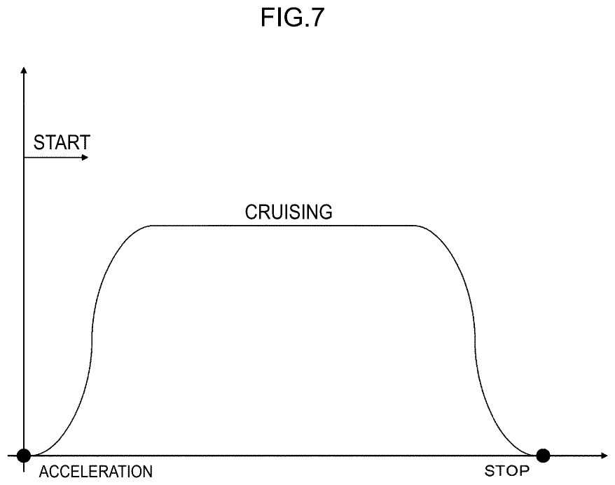

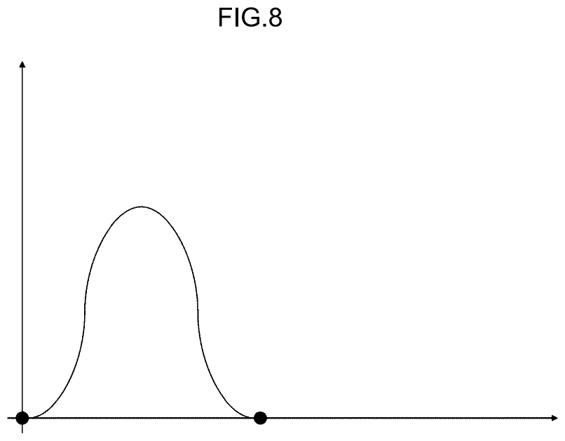

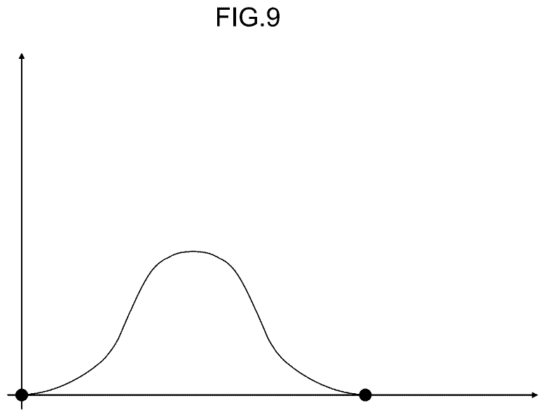

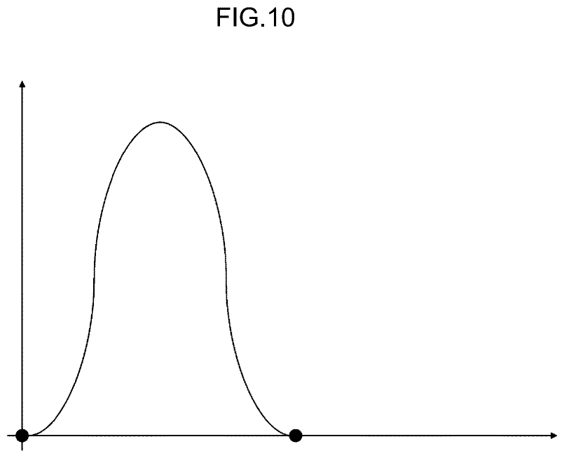

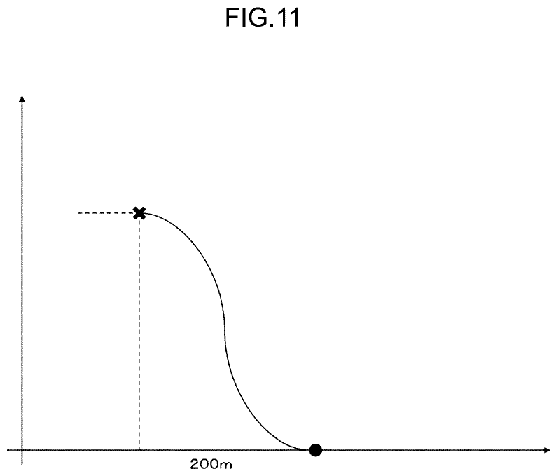

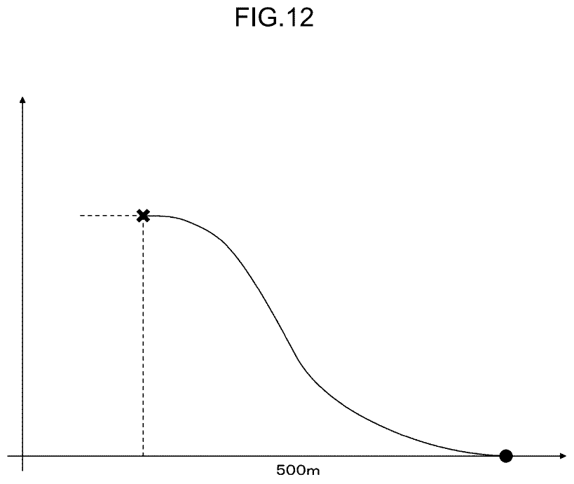

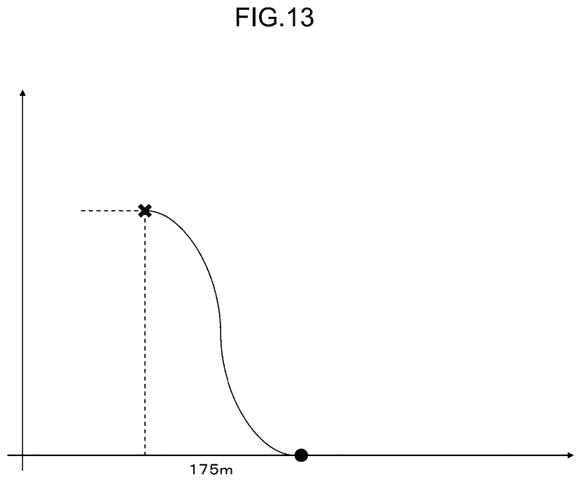

FIGS. 7 to 13 are schematic diagrams of the perfect cruising.

Next, a specific example of vehicle control by the central brain will be described. Hereinafter, a vehicle to be controlled by the central brain, the vehicle equipped with the central brain itself is referred to as a “host vehicle”.

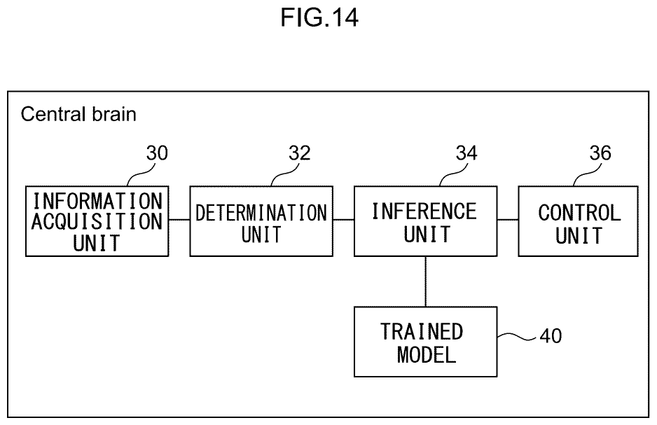

FIG. 14 is a block diagram illustrating an example of a functional configuration of the central brain. As illustrated in FIG. 14, the central brain includes an information acquisition unit 30, a determination unit 32, an inference unit 34, and a control unit 36. A trained model 40 is stored in a storage device included in the central brain. A function of the AI is implemented by the trained model 40.

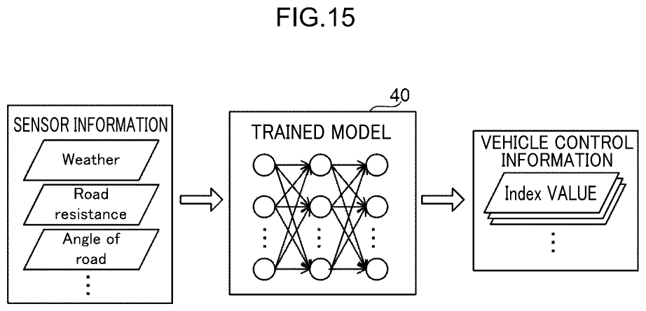

As an example, as illustrated in FIG. 15, the trained model 40 uses sensor information detected by various sensors as an input, and outputs an indexed value (hereinafter, referred to as an “index value”) related to control of a vehicle as control information for controlling driving of the vehicle. The trained model 40 is a model obtained by machine learning, more specifically, deep learning.

The information acquisition unit 30 acquires a plurality of pieces of information detected by the sensor mounted on the host vehicle. The information acquisition unit 30 acquires a plurality of pieces of information detected by the sensor 110 installed in the traffic signal 100.

The determination unit 32 determines whether the host vehicle enters the intersection at which the traffic signal 100 is installed or whether the host vehicle travels a travel path other than the intersection. For this determination, the determination unit 32 uses, for example, position information and map information of the host vehicle measured by a GPS device mounted on the host vehicle. For this determination, the determination unit 32 may use an image around the host vehicle captured by a digital camera included in a sensor group mounted on the host vehicle. The determination unit 32 may determine that the host vehicle enters the intersection in a case where communication with the sensor 110 installed in the traffic signal 100 becomes possible.

In a case where the determination unit 32 determines that the host vehicle enters the intersection, the inference unit 34 inputs the plurality of pieces of information detected by the sensor 110 installed in the traffic signal 100 acquired by the information acquisition unit 30 to the trained model 40. In a case where the determination unit 32 determines that the host vehicle travels a travel path other than the intersection, the inference unit 34 inputs the plurality of pieces of information detected by the sensor mounted on the host vehicle acquired by the information acquisition unit 30 to the trained model 40. The trained model 40 outputs a plurality of index values according to the plurality of pieces of input information. The index value is an example of an output value of the trained model 40.

As described above, the inference unit 34 infers the index value on the basis of the plurality of pieces of sensor information. The inference unit 34 can obtain an accurate index (index) value by performing multi-variate analysis (refer to, for example, Formula (2)) by an integration method as represented by the following Formula (1) using calculation power of the level 6 on data for every nanosecond collected by many sensor groups or the like. More specifically, while obtaining an integrated value of various ultra high resolution delta values with the calculation power of the level 6, an indexed value of each variable is obtained at an edge level and in real time, and a result that occurs in a next nanosecond can be obtained as the highest probability theoretical value.

$$[ Formula 1 ]$$

$$v = {\int }_{a}^{b} f ( A ) dt \qquad ( 1 )$$

$$[ Formula 2 ]$$

$${V}_{n} = DL ( f ( A , B , C , D , ⋯ , N ) ( {dA}_{n} / dt ) ) \qquad ( 2 )$$

DL in the formula represents deep learning, and A, B, C, D, . . . , and N represent air resistance, road resistance, road element (for example, dust), slip coefficient or the like.

The indexed value of each variable obtained by the inference unit 34 can be further refined by increasing the number of times of deep learning. For example, it is possible to calculate a more accurate index value using enormous data such as rotation of a tire and a motor, a steering angle, a road material, weather, a dust, an influence at the time of secondary curved deceleration, slip, collapse of balance and steering for re-acquisition, and a manner of performing speed control.

The control unit 36 may execute driving control of the host vehicle on the basis of the plurality of index values specified by the inference unit 34. The control unit 36 may be able to implement autonomous driving control of the host vehicle. Specifically, it is possible to acquire the highest probability theoretical value of the result occurring in the next nanosecond from the plurality of index values and to perform the driving control of the vehicle in consideration of the probability theoretical value. This control may be performed using, for example, a lookup table in which a combination of a plurality of index values and a control parameter for controlling driving of the vehicle are associated with each other. This control may be performed using, for example, a trained model having a plurality of index values as an input and a control parameter for controlling driving of the vehicle as an output. Examples of the control parameters include parameters for controlling the speed, acceleration, travel direction or the like of the vehicle.

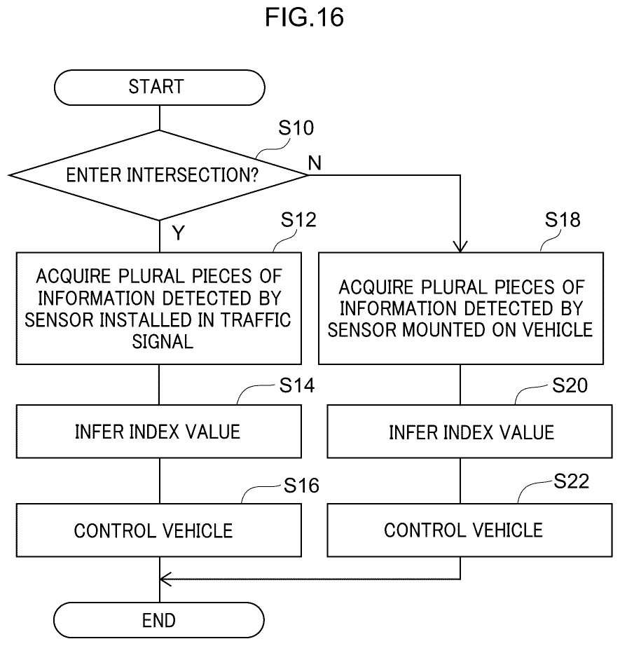

The central brain repeatedly executes a flowchart illustrated in FIG. 16.

At step S10, the determination unit 32 determines whether or not the host vehicle enters the intersection. In a case where the determination at step S10 is affirmative, the processing proceeds to step S12. At step S12, the information acquisition unit 30 acquires the plurality of pieces of information detected by the sensor 110 installed in the traffic signal 100.

At step S14, as described above, the inference unit 34 inputs the plurality of pieces of information detected by the sensor 110 installed in the traffic signal 100 acquired at step S12 to the trained model 40, thereby inferring a plurality of index values. At step S16, as described above, the control unit 36 executes driving control of the host vehicle on the basis of the plurality of index values specified at step S14. When the processing at step S16 ends, the processing of the flowchart ends.

In contrast, in a case where the determination unit 32 determines that the host vehicle travels a travel path other than the intersection, a negative determination is made at step S10, and the processing proceeds to step S18. At step S18, the information acquisition unit 30 acquires a plurality of pieces of information detected by the sensor mounted on the host vehicle.

At step S20, as described above, the inference unit 34 inputs the plurality of pieces of information detected by the sensor mounted on the host vehicle acquired at step S18 to the trained model 40, thereby inferring a plurality of index values. At step S22, as described above, the control unit 36 executes driving control of the host vehicle on the basis of the plurality of index values specified at step S20. When the processing at step S22 ends, the processing of the flowchart ends.

The control unit 36 may control the host vehicle using the plurality of pieces of information detected by the sensor 110 installed in the traffic signal 100 and the trained model 40 in a case where the determination unit 32 determines that the host vehicle enters the intersection and in a case where the output value of the trained model 40 in a case where the plurality of pieces of information detected by the sensor 110 installed in the traffic signal 100 is input to the trained model 40 matches the output value of the trained model 40 in a case where the plurality of pieces of information detected by the sensor mounted on the host vehicle is input to the trained model 40. In this case, it is possible to suppress a sudden change in behavior of the host vehicle in a case where the host vehicle enters the intersection. In a case where these output values do not match, the control unit 36 continuously controls the host vehicle using the plurality of pieces of information detected by the sensor mounted on the host vehicle and the trained model 40.

As described above, according to the present embodiment, the sensor 110 capable of communicating with the central brain of the level 6 autonomous vehicle is installed in all the traffic signals 100 in town. The central brain of the level 6 autonomous vehicle can acquire information of a blind spot region from the sensor 110.

Therefore, since the information of the blind spot region that cannot be detected from the autonomous vehicle can be acquired, a risk of a traffic accident can be reduced. Since the autonomous vehicle can enter the intersection even in the case of red light and can accurately operate at high speed, a traffic volume of the entire town can be increased by 10 times or the like. As a result, GDP rises significantly.

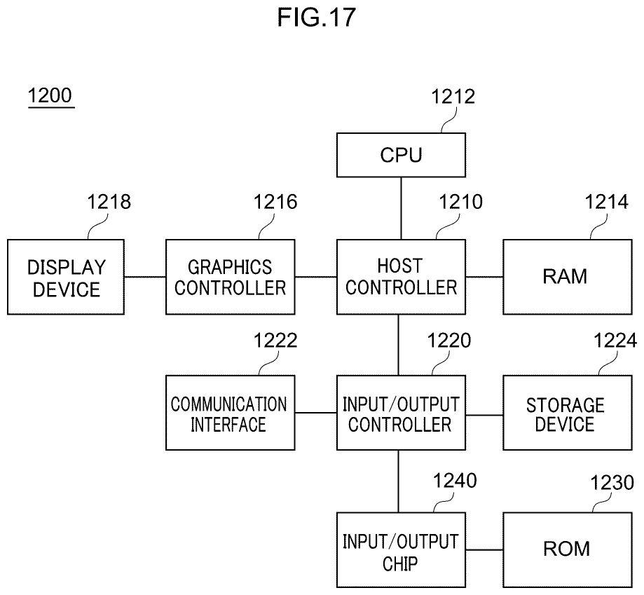

FIG. 17 schematically illustrates an example of a hardware configuration of a computer 1200 functioning as a central brain, which is an example of a control device. A program installed in the computer 1200 can cause the computer 1200 to function as one or a plurality of “units” of a device according to the present embodiment, or cause the computer 1200 to execute an operation associated with the device according to the present embodiment or the one or the plurality of “units”, and/or cause the computer 1200 to execute a process according to the present embodiment or a stage of the process. Such program may be executed by a CPU 1212 in order to cause the computer 1200 to execute a specific operation associated with some or all of blocks in the flowchart and block diagram described in this specification.

The computer 1200 according to the present embodiment includes the CPU 1212, a RAM 1214, and a graphics controller 1216, which are mutually connected by a host controller 1210. The computer 1200 also includes input/output units such as a communication interface 1222, a storage device 1224, a DVD drive, and an IC card drive, which are connected to the host controller 1210 via an input/output controller 1220. The DVD drive may be a DVD-ROM drive, a DVD-RAM drive or the like. The storage device 1224 may be a hard disk drive, a solid state drive or the like. The computer 1200 also includes a ROM 1230 and a legacy input/output unit such as a keyboard, which are connected to the input/output controller 1220 via an input/output chip 1240.

The CPU 1212 operates according to a program stored in the ROM 1230 and the RAM 1214, thereby controlling each unit. The graphics controller 1216 acquires image data generated by the CPU 1212 in a frame buffer or the like provided in the RAM 1214 or itself, and causes the image data to be displayed on a display device 1218.

The communication interface 1222 communicates with another electronic device via a network. The storage device 1224 stores a program and data used by the CPU 1212 in the computer 1200. The DVD drive reads a program or data from a DVD-ROM or the like and provides the same to the storage device 1224. The IC card drive reads a program and data from an IC card and/or writes a program and data in the IC card.

The ROM 1230 stores therein a boot program or the like executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port or the like.

The program is provided by a computer-readable storage medium such as a DVD-ROM or an IC card. The program is read from the computer-readable storage medium, installed in the storage device 1224, the RAM 1214, or the ROM 1230, which is also an example of the computer-readable storage medium, and executed by the CPU 1212. Information processing described in these programs is read by the computer 1200 and provides cooperation between the program and the various types of hardware resources. A device or a method may be configured by operation of information or by implementing processing according to use of the computer 1200.

For example, in a case where communication is executed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM, or the IC card, transmits the read transmission data to the network, or writes reception data received from the network in a reception buffer area or the like provided on the recording medium.

The CPU 1212 may cause the RAM 1214 to read an entire or necessary portion of a file or database stored in an external recording medium such as the storage device 1224, a DVD drive (DVD-ROM), an IC card or the like, and may execute various types of processing on data on the RAM 1214. Next, the CPU 1212 may write back the processed data in the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information retrieval/replacement or the like, which are described throughout the present disclosure and specified by an instruction sequence of a program, and writes back the results in the RAM 1214. The CPU 1212 may search for information in the file, database or the like in the recording medium. For example, in a case where a plurality of entries each having an attribute value of a first attribute associated with an attribute value of a second attribute is stored in the recording medium, the CPU 1212 may search the plurality of entries for an entry in which the attribute value of the first attribute matches a specified condition, read the attribute value of the second attribute stored in the entry, thereby acquiring the attribute value of the second attribute associated with the first attribute satisfying the predetermined condition.

The program or software module described above may be stored in a computer-readable storage medium on the computer 1200 or in the vicinity of the computer 1200. A recording medium such as a hard disk or a RAM provided in a server system connected to a dedicated communication network or the Internet can be used as the computer-readable storage medium, thereby providing the program to the computer 1200 via the network.

The block in the flowchart and block diagram in the present embodiment may represent a stage of a process in which an operation is executed or a “unit” of a device responsible for executing the operation. A specific stage and “unit” may be implemented by a dedicated circuit, a programmable circuit supplied together with a computer-readable instruction stored on the computer-readable storage medium, and/or a processor supplied together with a computer-readable instruction stored on the computer-readable storage medium. Examples of the dedicated circuit may include a digital and/or analog hardware circuit, and may include an integrated circuit (IC) and/or a discrete circuit. Examples of the programmable circuit may include a reconfigurable hardware circuit including, for example, AND, OR, exclusive OR, NAND, NOR, and other logical operations, flip-flops, registers, and memory elements, such as a field programmable gate array (FPGA) and a programmable logic array (PLA).

A computer-readable storage medium may include any tangible device capable of storing an instruction executed by a suitable device, and as a result, the computer-readable storage medium having an instruction stored therein includes a product including instructions that may be executed to create means for executing an operation specified in the flowchart or block diagram. Examples of the computer-readable storage medium may include an electronic storage medium, a magnetic storage medium, an optical storage medium, an electromagnetic storage medium, a semiconductor storage medium or the like. More specific examples of the computer-readable storage medium may include a FLOPPY (Registered Trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (Registered Trademark) disk, a memory stick, an integrated circuit card or the like.

Examples of the computer-readable instruction may include either a source code or an object code described in any combination of one or a plurality of programming languages, including an assembler instruction, an instruction-set-architecture (ISA) instruction, a machine instruction, a machine-dependent instruction, a microcode, a firmware instruction, state-setting data, or an object oriented programming language such as Smalltalk (Registered Trademark), JAVA (Registered Trademark), and C++, and conventional procedural programming languages such as the “C” programming language or similar programming languages.

The computer-readable instruction may be provided to a processor or a programmable circuit of a general purpose computer, a special purpose computer, or other programmable data processing device, locally or over a local area network (LAN) or a wide area network (WAN) such as the Internet in order for the processor or programmable circuit of the general purpose computer, special purpose computer, or other programmable data processing device to execute the computer-readable instruction in order to generate a means for executing an operation specified in the flowcharts or block diagrams. Examples of the processor include a computer processor, a processing unit, a microprocessor, a digital signal processor, a controller, a microcontroller or the like.

### Second Embodiment

Next, a second embodiment of the present disclosure will be described. The same portion as that of the first embodiment is denoted by the same reference numeral, and the description thereof will be omitted.

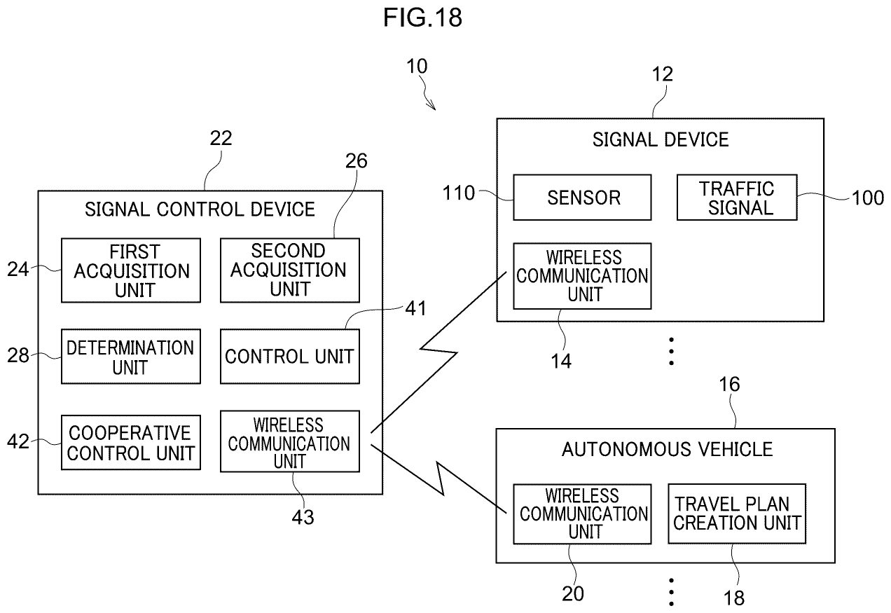

FIG. 18 illustrates a traffic signal system 10 according to the second embodiment. The traffic signal system 10 includes a plurality of signal devices 12 installed at each intersection of roads, a plurality of autonomous vehicles 16, and a signal control device 22. The signal device 12 includes the traffic signal 100 and the sensor 110 described in the first embodiment, and a wireless communication unit 14 for performing wireless communication with the signal control device 22. The sensor 110 in the second embodiment can detect a traffic condition such that, for example, an emergency vehicle (for example, a police vehicle, an ambulance, a fire engine or the like that travels while sounding a siren) is about to pass through the intersection at which the signal device 12 is installed.

The autonomous vehicle 16 includes a travel plan creation unit 18 and a wireless communication unit 20 for performing wireless communication with the signal control device 22. The travel plan creation unit 18 is implemented by the central brain described in the first embodiment executing a predetermined program. With setting of a destination of the autonomous vehicle 16 as a trigger, the travel plan creation unit 18 performs processing of creating a travel plan in which a route to the set destination is subdivided into travel schedules such as straight run and right/left turns at intersections, and scheduled execution time of individual travel schedule is also set. The central brain performs control to cause the autonomous vehicle 16 to travel by autonomous driving in accordance with the travel plan created by the travel plan creation unit 18.

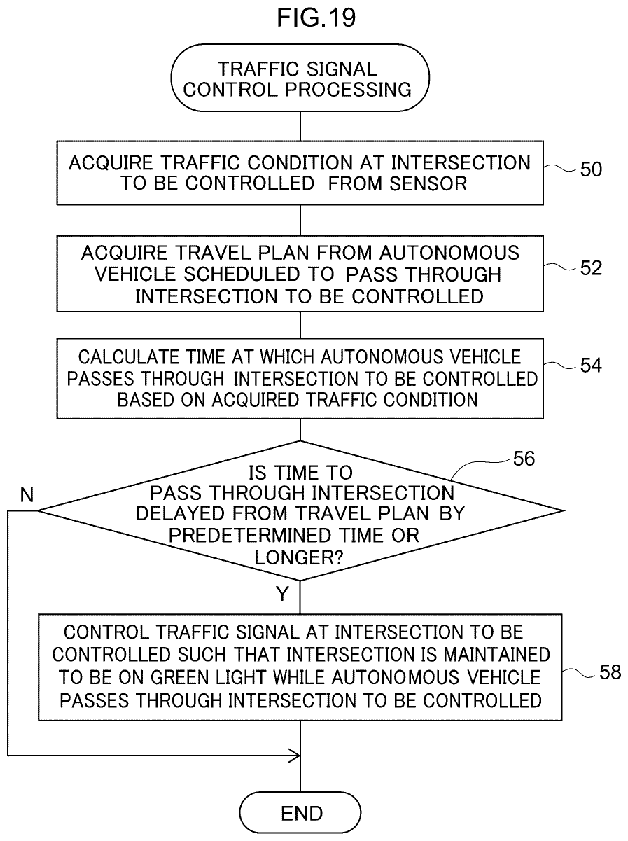

The signal control device 22 includes a CPU, a memory such as a ROM and a RAM, a nonvolatile storage unit such as an HDD and an SSD, and a wireless communication unit 43. A signal control program is stored in the storage unit. The signal control device 22 functions as a first acquisition unit 24, a second acquisition unit 26, a determination unit 28, a control unit 41, and a cooperative control unit 42 when the CPU executes the signal control program, and performs signal control processing (FIG. 19) to be described later. The signal control device 22 is an example of the signal control device in the present disclosure.

The first acquisition unit 24 acquires the traffic condition around the intersection from the sensor 110 provided around the intersection. The second acquisition unit 26 acquires the travel plan of the autonomous vehicle 16 scheduled to pass through the intersection. On the basis of the traffic condition around the intersection acquired by the first acquisition unit 24, the determination unit 28 determines whether or not a delay in the travel plan of the autonomous vehicle 16 occurs when the autonomous vehicle 16 passes through the intersection.

In a case where the determination unit 28 determines that the delay in the travel plan of the autonomous vehicle 16 occurs when the autonomous vehicle 16 passes through the intersection, the control unit 41 controls the traffic signal 100 at the intersection so that the delay in the travel plan of the autonomous vehicle 16 is suppressed when the autonomous vehicle 16 passes through the intersection. In a case where the determination unit 28 determines that the delay in the travel plan of the autonomous vehicle 16 occurs, the cooperative control unit 42 controls each of the traffic signals 100 at a plurality of intersections through which the autonomous vehicle 16 is scheduled to sequentially pass so that the delay in the travel plan of the autonomous vehicle 16 is suppressed.

Next, an effect of the second embodiment will be described. In the second embodiment, the signal control device 22 periodically communicates with individual autonomous vehicles 16 traveling on the road to constantly grasp a position, a speed or the like of the individual autonomous vehicles 16. The signal control device 22 performs the signal control processing illustrated in FIG. 19 with the approach of any of the autonomous vehicles 16 within a predetermined distance from the intersection (hereinafter, referred to as an intersection to be controlled) at which the signal device 12 is installed as a trigger.

At step 50 of the signal control processing, the first acquisition unit 24 of the signal control device 22 acquires the traffic condition at the intersection to be controlled, for example, the traffic condition such as whether the emergency vehicle is about to pass through the intersection to be controlled, from the sensor 110.

At step 52, the second acquisition unit 26 acquires the travel plan from the autonomous vehicle 16 scheduled to pass through the intersection to be controlled. Here, the travel plan acquired by the second acquisition unit 26 from the autonomous vehicle 16 includes each piece of information of a travel schedule (straight run/left turn/right turn) of the autonomous vehicle 16 at the intersection to be controlled and a scheduled execution time of the travel schedule (scheduled passage time at the intersection to be controlled).

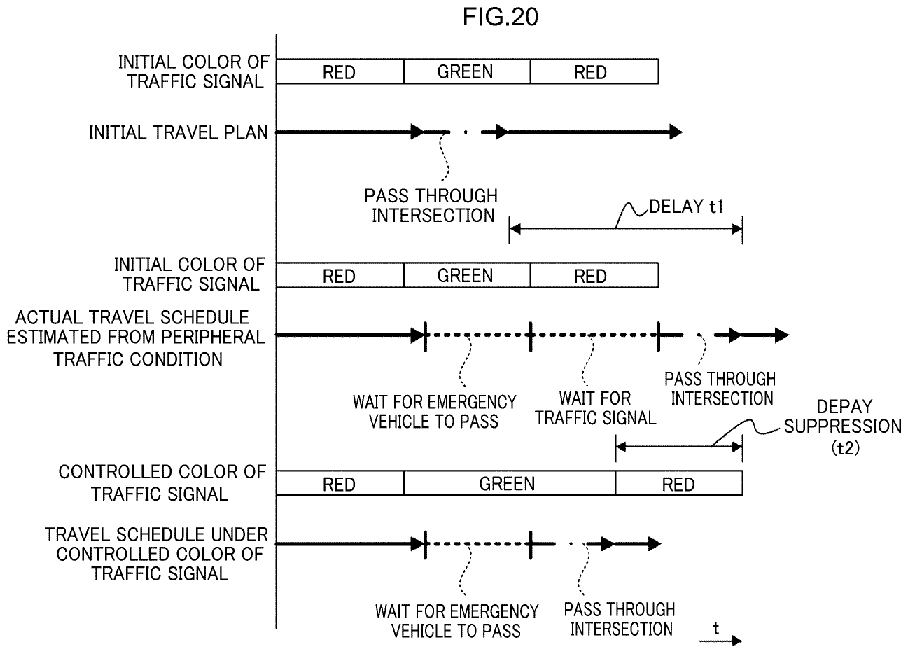

As an example, in FIG. 20, an example of the travel plan of the autonomous vehicle 16 acquired by the second acquisition unit 26 is denoted as an “initial travel plan”. In this “initial travel plan”, while the traffic signal 100 at the intersection to be controlled is on a green light, the vehicle can pass through the intersection to be controlled without waiting for a traffic signal.

At step 54, the determination unit 28 calculates the time at which the autonomous vehicle 16 passes through the intersection to be controlled on the basis of the traffic condition at the intersection to be controlled acquired by the first acquisition unit 24 at step 50. At step 56, the determination unit 28 determines whether or not the intersection passage time calculated at step 54 is delayed by a predetermined time or longer from the travel plan of the autonomous vehicle 16 (scheduled passage time at the intersection to be controlled).

For example, in a case where there is no emergency vehicle about to pass through the intersection to be controlled or the like, a time difference between the time calculated at step 54 and the travel plan of the autonomous vehicle 16 (scheduled passage time at the intersection to be controlled) is less than a predetermined time, so that the determination at step 56 is negative. In this case, step 58 is skipped, and the signal control processing is ended.

In contrast, in a case where there is an emergency vehicle about to pass through the intersection to be controlled, as an example, as indicated by “actual travel schedule estimated from surrounding traffic condition” in FIG. 20, a time for waiting for the emergency vehicle to pass and a time for waiting for a traffic signal are added to the time required for passing through the intersection to be controlled. As a result, as indicated by “delay t1” in FIG. 20, the time calculated at step 54 is delayed by a predetermined time or longer with respect to the travel plan of the autonomous vehicle 16 (scheduled passage time through the intersection to be controlled), so that the determination at step 56 is affirmed and the processing proceeds to step 58.

At step 58, the control unit 41 controls the traffic signal 100 at the intersection to be controlled such that the traffic signal 100 at the intersection to be controlled is maintained to be the green light while the autonomous vehicle 16 passes through the intersection to be controlled (refer also to “color of traffic signal after control” illustrated in FIG. 20), and the signal control processing is ended. Therefore, as indicated by “travel schedule under the color of the traffic signal after control” in FIG. 20 as an example, the time required to pass through the intersection to be controlled is shortened by the time for waiting for the traffic signal (refer also to “delay suppression (t2)”), and occurrence of the delay in the travel plan of the autonomous vehicle 16 is suppressed.

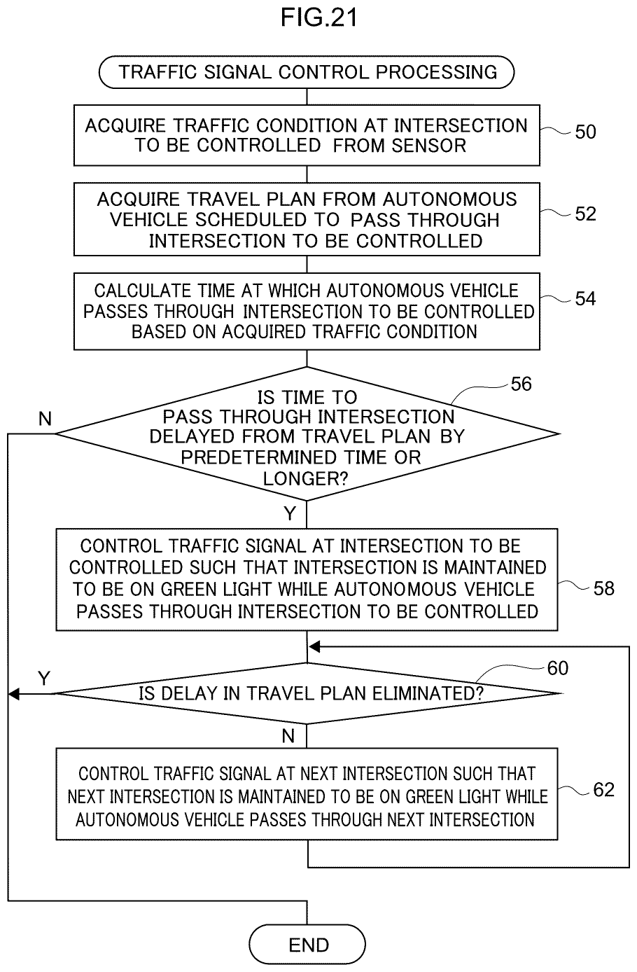

Subsequently, another example of the signal control processing executed by the signal control device 22 will be described with reference to FIG. 21. The signal control processing illustrated in FIG. 21 performs the processing at step 58, and then proceeds to step 60. At step 60, the cooperative control unit 42 determines whether or not the delay in the travel plan of the autonomous vehicle 16 is eliminated in accordance with the control of the traffic signal 100 at the intersection to be controlled at step 58. In a case where the determination at step 60 is affirmed, the signal control processing is ended.

In contrast, in a case where the determination at step 60 is negative, the processing proceeds to step 62. At step 62, while the autonomous vehicle 16 passes through a next intersection, the cooperative control unit 42 controls the traffic signal 100 at the next intersection such that the traffic signal 100 at the next intersection is maintained to be the green light. When the processing at step 62 is performed, the processing returns to step 60, and steps 60 and 62 are repeated until the determination at step 60 is affirmed. As a result, the traffic signals 100 at a plurality of intersections through which the autonomous vehicle 16 sequentially passes is cooperatively controlled so as to eliminate the delay in the travel plan of the autonomous vehicle 16.

As described above, in the second embodiment, the first acquisition unit 24 of the signal control device 22 acquires the traffic condition around the intersection to be controlled from the sensor 110 provided around the intersection to be controlled, and the second acquisition unit 26 acquires the travel plan of the autonomous vehicle 16 scheduled to pass through the intersection to be controlled. On the basis of the traffic condition acquired by the first acquisition unit 24, the determination unit 28 determines whether or not the delay in the travel plan of the autonomous vehicle 16 occurs when the autonomous vehicle 16 passes through the intersection. In a case where the determination unit 28 determines that the delay occurs, the control unit 41 controls the traffic signal 100 at the intersection to be controlled so as to suppress the delay. As a result, it is possible to suppress occurrence of the delay in the travel plan of the autonomous vehicle 16, and it is possible to suppress application of a large load such as re-creation of the travel plan to an in-vehicle computer (central brain) that performs autonomous driving control and the like during travel.

In the second embodiment, in case where the determination unit 28 determines that the delay occurs, the control unit 41 controls the traffic signal 100 at the intersection to be controlled so that the traffic signal 100 at the intersection to be controlled is maintained to be the green light while the autonomous vehicle 16 passes through the intersection to be controlled. As a result, it is possible to suppress the time in which the traffic signal at the intersection to be controlled is on the green light from becoming longer than necessary while ensuring the safety when the autonomous vehicle 16 passes through the intersection to be controlled as compared with the case of performing control such as increasing the time in which the traffic signal 100 at the intersection to be controlled is on the green light for a certain period of time.

In the second embodiment, in a case where the determination unit 28 determines that the delay occurs, the cooperative control unit 42 controls each of the traffic signals 100 at a plurality of intersections through which the autonomous vehicle 16 is scheduled to sequentially pass so that the delay is suppressed (FIG. 21). As a result, it is possible to eliminate the delay in the travel plan of the autonomous vehicle 16 while the autonomous vehicle 16 sequentially passes through the plurality of intersections.

In the second embodiment, an aspect has been described in which the processing of controlling the traffic signal 100 at the intersection to be controlled in a case where the travel plan of the autonomous vehicle 16 is delayed is performed for all the autonomous vehicles 16 passing through the intersection to be controlled, but the present disclosure is not limited thereto. For example, a degree of urgency may be set in advance for individual autonomous vehicles 16, and the processing of controlling the traffic signal 100 at the intersection to be controlled in a case where the travel plan of the autonomous vehicle 16 is delayed may be performed for the autonomous vehicle 16 having the degree of urgency equal to or higher than a predetermined value. As a result, for example, by setting the degree of urgency of the autonomous vehicle 16 or the like carrying a sick person to a predetermined value or higher, it is possible to preferentially suppress occurrence of the delay in the travel plan for the autonomous vehicle 16. Since the number of times of controlling the traffic signal 100 at the intersection to be controlled is suppressed, it is also possible to suppress the number of other vehicles other than the autonomous vehicle 16 having the degree of urgency equal to or higher than the predetermined value of which travel might be affected along with the control of the traffic signal 100 at the intersection to be controlled.

In the second embodiment, as an example of the traffic condition in which the travel plan of the autonomous vehicle 16 is delayed, the case where the autonomous vehicle 16 encounters the emergency vehicle at the intersection has been described. However, the present disclosure is not limited to this, and other examples of the traffic condition in which the travel plan of the autonomous vehicle 16 is delayed include a case where there is a pedestrian who interferes with the autonomous vehicle 16 when the autonomous vehicle 16 turns right or left at an intersection.

In the second embodiment, an aspect in which one signal control device 22 is provided for a plurality of signal devices 12 has been described, but the present disclosure is not limited thereto. For example, the signal control device 22 including each functional unit (the first acquisition unit 24, second acquisition unit 26, determination unit 28, and control unit 41) excluding the cooperative control unit 42 may be provided at individual intersections corresponding to individual signal device 12. In this aspect, the devices (the signal device 12 and signal control device 22) provided at the individual intersections serve an example of the traffic signal device according to the present disclosure. In this aspect, in a case where the cooperative control of the plurality of traffic signals 100 is performed, one cooperative control device functioning as the cooperative control unit 42 may be provided for a plurality of traffic signal devices (signal devices 12 and signal control devices 22). The traffic signal system 10 in the aspect in which the cooperative control device is provided is an example of the traffic signal system according to the present disclosure.

### Third Embodiment

Next, a third embodiment of the present disclosure will be described. The same portion as that of the first embodiment is denoted by the same reference numeral, and the description thereof will be omitted.

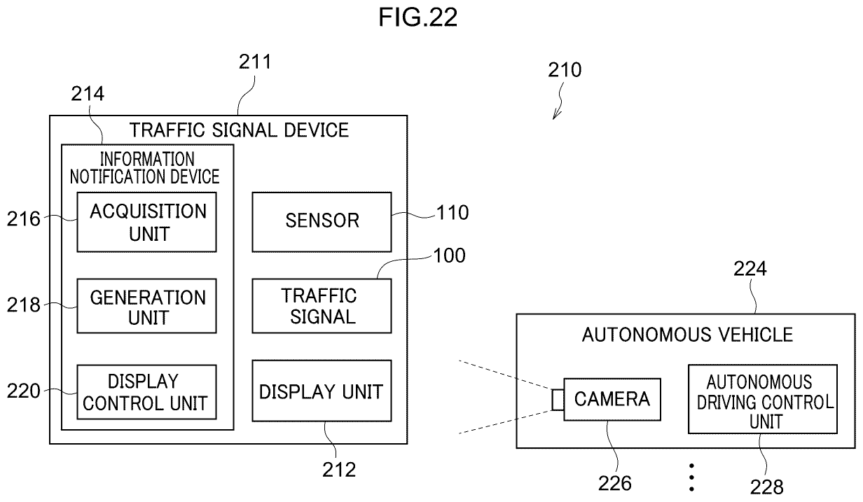

FIG. 22 illustrates an information notification system 210 according to the third embodiment. The information notification system 210 includes a plurality of traffic signal devices 211 installed at each intersection of roads and a plurality of autonomous vehicles 224 traveling on the roads. The traffic signal device 211 includes the traffic signal 100 and sensor 110 described in the first embodiment, a display unit 212, and an information notification device 214. In the first embodiment, the sensor 110 is configured to be able to perform wireless communication with the central brain of the autonomous vehicle 224, but in the sensor 110 in the third embodiment, a function of performing wireless communication with the autonomous vehicle 224 or the like may be omitted.

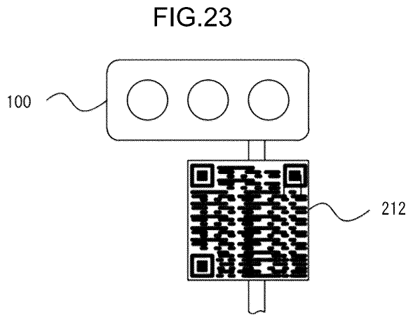

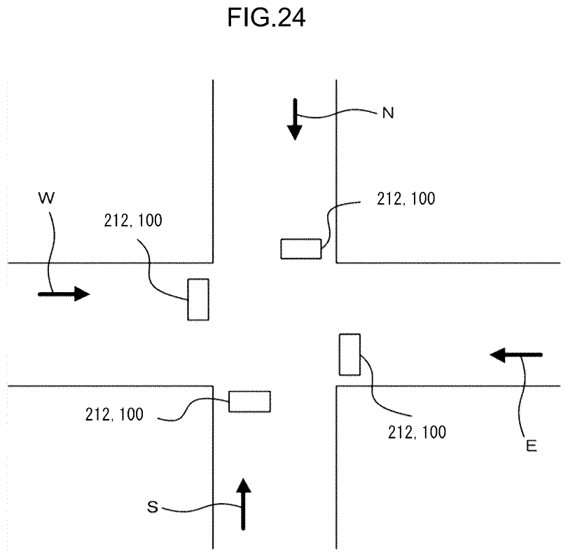

As illustrated in FIG. 23, the display unit 212 is installed in the vicinity of the traffic signal 100 and has a resolution capable of displaying a predetermined two-dimensional code. Although only one display unit 212 is illustrated in FIG. 23, the display unit 212 (and the traffic signal 100) is provided for respective roads of different approach directions to the intersection. For example, as illustrated in FIG. 24, in the case of an intersection at which a road extending in an east-west direction and a road extending in a north-south direction intersect with each other, separate display units 212 are provided for respective approach directions to the intersection of “east (E)”, “west (W)”, “south(S)”, and “north (N)”.

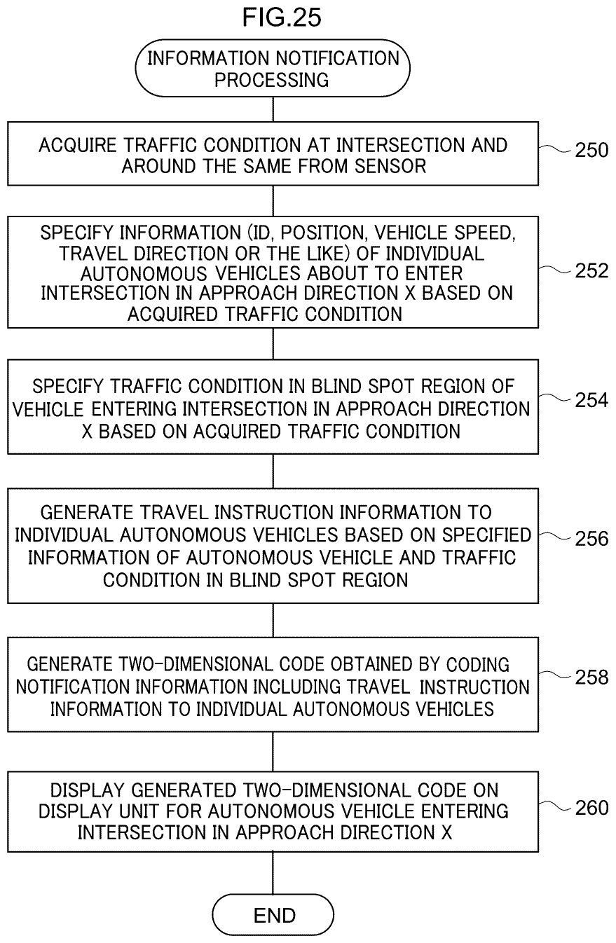

The information notification device 214 includes a CPU, a memory such as a ROM and a RAM, and a nonvolatile storage unit such as an HDD and an SSD, and an information notification program is stored in the storage unit. When the CPU executes the information notification program, the information notification device 214 functions as an acquisition unit 216, a generation unit 218, and a display control unit 220, and performs information notification processing (FIG. 25) to be described later. The information notification device 214 is an example of the information notification device according to the present disclosure.

The acquisition unit 216 acquires a traffic condition around the intersection from the sensor 110 provided around the intersection. The generation unit 218 generates notification information for the autonomous vehicle 224 about to enter the intersection on the basis of the traffic condition around the intersection acquired by the acquisition unit 216. The display control unit 220 displays the notification information generated by the generation unit 218 on the display unit 212 provided around the intersection as code information (two-dimensional code in the third embodiment).

The autonomous vehicle 224 includes a camera 226 capable of capturing the display unit 212, and an autonomous driving control unit 228. The autonomous driving control unit 228 is implemented by the central brain described in the first embodiment executing a predetermined program. The autonomous driving control unit 228 acquires the notification information by decoding the code information displayed in an area corresponding to the display unit 212 in the image captured by the camera 226. The autonomous driving control unit 228 (central brain) performs control to cause the autonomous vehicle 224 to travel by autonomous driving according to the acquired notification information (more specifically, travel instruction information for a host vehicle included in the notification information).

Next, as an effect of the third embodiment, information notification processing repeatedly executed at a predetermined time cycle by the information notification device 214 will be described with reference to FIG. 25. The information notification processing illustrated in FIG. 25 is processing for the autonomous vehicle 224 entering the intersection in a specific approach direction (hereinafter, referred to as an approach direction X), and the information notification device 214 performs the information notification processing of FIG. 25 also for approach directions other than the approach direction X.

At step 250 of the information notification processing, the acquisition unit 216 of the information notification device 214 acquires the intersection at which the traffic signal device 211 is installed (hereinafter, simply referred to as an “intersection”) and the traffic condition around the same from the sensor 110.

At step 252, the generation unit 218 specifies the autonomous vehicle 224 about to enter the intersection in the approach direction X on the basis of the traffic condition acquired at step 250, and specifies each information (ID, position, vehicle speed, travel direction (straight run/right turn/left turn) or the like) of the specified autonomous vehicle 224. As the ID of the autonomous vehicle 224, for example, a character string indicated in a number plate (license plate) or the like can be applied. The travel direction of the autonomous vehicle 224 can be specified from, for example, presence or absence of blinking of a blinker lamp or the like.

In the third embodiment, the autonomous vehicle 224 is provided with a lamp at a position that can be discriminated from the outside, such as a roof, and is configured to turn on the lamp in a case where the autonomous driving control unit 228 performs autonomous driving. At step 252, the generation unit 218 specifies the autonomous vehicle 224 about to enter the intersection in the approach direction X by determining whether a lamp is provided on a roof or the like and the lamp is turned on for individual vehicles about to enter the intersection in the approach direction X.

At step 254, the generation unit 218 specifies a traffic condition in a blind spot region (for example, a hatched region in FIG. 3) that is a blind spot from a vehicle entering the intersection in the approach direction X on the basis of the traffic condition acquired at step 250. The traffic condition in the blind spot region includes, for example, information such as presence or absence or the number, the position, the travel direction, and the moving speed of traffic participants such as vehicles and pedestrians in the blind spot region.

At step 256, the generation unit 218 generates the travel instruction information to individual autonomous vehicles 224 on the basis of the information of the autonomous vehicle 224 about to enter the intersection in the approach direction X specified at step 252 and the traffic condition in the blind spot region specified at step 254.

As an example, the generation unit 218 determines whether or not the autonomous vehicle 224 of which travel direction is “straight run” among the individual autonomous vehicles 224 about to enter the intersection in the approach direction X can pass through the intersection within a period in which the intersection is on a green light when the autonomous vehicle travels at the current vehicle speed. The generation unit 218 generates travel notification information instructing a first autonomous vehicle 224 determined to be able to pass through the intersection in a period in which the intersection is on the green light “to travel while maintaining the current vehicle speed” for, and generates travel notification information instructing “to decelerate and stop before the intersection” for a second autonomous vehicle 224 determined to be unable to pass through the intersection in the period in which the intersection is on the green light. The travel notification information for each autonomous vehicle 224 includes the ID of the corresponding autonomous vehicle 224 as information.

As an example, the generation unit 218 determines whether or not the autonomous vehicle 224 of which travel direction is “right turn” or “left turn” among the individual autonomous vehicles 224 about to enter the intersection in the approach direction X interferes with a pedestrian or the like present in a blind spot region when turning right or left. The generation unit 218 generates travel notification information for instructing a third autonomous vehicle 224 determined not to interfere with the pedestrian or the like present in the blind spot region at the time of right or left turn to “go slowly and pass through a pedestrian crossing at the time of right or left turn”, and generates travel notification information for instructing a fourth autonomous vehicle 224 determined to interfere with the pedestrian or the like present in the blind spot region at the time of right or left turn to “temporarily stop before the pedestrian crossing at the time of right or left turn”.

At step 258, the display control unit 220 generates a two-dimensional code in which the notification information including the travel instruction information for each autonomous vehicle 224 about to enter the intersection in the approach direction X generated at step 256 is coded. At step 260, the display control unit 220 displays the two-dimensional code generated at step 258 on the display unit 212 for the autonomous vehicle 224 that enters the intersection in the approach direction X, and ends the information notification processing.

In the information notification processing described above, when the code information is displayed on the display unit 212 and notified to the autonomous vehicle 224, in a case where the color of the traffic signal 100 is changed from green to yellow and then to red, the code information is changed in accordance with the color of the traffic signal 100. A timing at which the code information displayed on the display unit 212 is changed may be the same timing as the color of the traffic signal 100 is changed, or may be a timing a predetermined time before the color of the traffic signal 100 is changed.

In the autonomous vehicle 224 about to enter the intersection, the autonomous driving control unit 228 acquires the notification information by decoding the code information displayed in an area corresponding to the display unit 212 in the image captured by the camera 226. The autonomous driving control unit 228 extracts the travel instruction information for the host vehicle from the ID included in the acquired notification information, and performs control to cause the autonomous vehicle 224 to travel by autonomous driving according to the extracted travel instruction information.

As a result, for example, the first autonomous vehicle 224 is controlled to “travel while maintaining the current vehicle speed” according to the travel instruction information for the host vehicle, and the second autonomous vehicle 224 is controlled to “decelerate and stop before the intersection” according to the travel instruction information for the host vehicle. For example, the third autonomous vehicle 224 is controlled to “go slowly and pass through a pedestrian crossing at the time of right or left turn” according to the travel instruction information for the host vehicle, and the fourth autonomous vehicle 224 is controlled to “temporarily stop before the pedestrian crossing at the time of right or left turn” according to the travel instruction information for the host vehicle.

As described above, in the third embodiment, the acquisition unit 216 of the information notification device 214 acquires the traffic condition around the intersection from the sensor 110 provided around the intersection. The generation unit 218 generates the notification information for the autonomous vehicle about to enter the intersection on the basis of the traffic condition around the intersection acquired by the acquisition unit 216. The display control unit 220 displays the notification information generated by the generation unit 218 on the display unit 212 provided around the intersection as the code information. As a result, since the autonomous vehicle 224 can be notified of the notification information without using a mobile communication network, the autonomous vehicle 224 can be notified of the information without being affected by a communication status of the mobile communication network.

In the third embodiment, the generation unit 218 generates, as the notification information, information including the travel instruction information for instructing each of a plurality of autonomous vehicles 224 entering the intersection to travel. As a result, by displaying single notification information as the code information on the display unit 212, it is possible to give a travel instruction to each of the plurality of autonomous vehicles 224 about to enter the intersection.

In the third embodiment, the generation unit 218 generates the travel instruction information in consideration of the traffic condition in the blind spot region that is a blind spot region from the autonomous vehicle 224 around the intersection. As a result, it is possible to give a travel instruction to the autonomous vehicle 224 in consideration of the traffic condition in the blind spot region, which is the blind spot from the autonomous vehicle 224.

In the third embodiment, the display control unit 220 displays a two-dimensional barcode on the display unit 212 as the code information. As a result, it is possible to increase an information amount of the notification information that can be displayed as the code information on the display unit 212, as compared with an aspect in which a one-dimensional code is displayed as the code information.

In the third embodiment described above, the aspect of generating the travel instruction information in consideration of the traffic condition in the blind spot region has been described, but the present disclosure is not limited thereto, and information indicating the situation in the blind spot region may be included in the notification information as blind spot region information. It is possible that the blind spot region information is included in the notification information only for an intersection at which visibility is poor and the blind spot region occurs in an in-vehicle sensor.

In the third embodiment described above, the aspect has been described in which the notification information is displayed on the display unit 212 as the two-dimensional code, which is an example of the code information in the present disclosure, but the code information in the present disclosure may be, for example, a one-dimensional barcode or the like in addition to the two-dimensional code.

In the third embodiment described above, the aspect in which the information notification device 214 according to the present disclosure is provided side by side with the traffic signal 100 to form a part of the traffic signal device 211 has been described; however, the present disclosure is not limited to this, and the information notification device 214 according to the present disclosure can be installed together with the sensor 110 at an intersection at which the traffic signal 100 is not installed, a merging point at which a plurality of roads merge without the traffic signal 100 installed or the like.

Although the present disclosure has been described above with reference to the embodiments, the technical scope of the present disclosure is not limited to the scope described in the above embodiments. It is apparent to those skilled in the art that various modifications or improvements can be made to the above embodiments. It is apparent from recitation in claims that a mode to which such modification or improvement is added can also be included in the technical scope of the present disclosure.

It should be noted that the order of execution of each processing such as operations, procedures, steps, and stages in the devices, systems, programs, and methods recited in claims, described in the specification, and illustrated in the drawings may be implemented in any order unless “before”, “prior to” or the like is specifically stated, and unless the output of the previous processing is used in the later processing. Even when the operation flow in claims, the specification, and the drawings is described using “first”, “next” or the like for convenience, it does not mean that it is essential to perform in this order.

The disclosure of Japanese Patent Application No. 2022-165875 filed on Oct. 14, 2022, the disclosure of Japanese Patent Application No. 2022-172347 filed on Oct. 27, 2022, the disclosure of Japanese Patent Application No. 2023-036942 filed on Mar. 9, 2023, and the disclosure of Japanese Patent Application No. 2023-041210 filed on Mar. 15, 2023 are incorporated herein by reference in their entirety.

### REFERENCE SIGNS LIST

10 Signal control system
12 Signal device
16 Autonomous vehicle
18 Travel plan creation unit
22 Signal control device
24 First acquisition unit
26 Second acquisition unit
28 Determination unit
30 Information acquisition unit
32 Determination unit
34 Inference unit
36 Control unit
40 Trained model
41 Control unit
42 Cooperative control unit
100 Traffic signal
110 Sensor
210 Information notification system
211 Traffic signal device
212 Display unit
216 Acquisition unit
218 Generation unit
220 Display control unit
224 Autonomous vehicle
1200 Computer
1210 Host controller
1212 CPU
1214 RAM
1216 Graphics controller
1218 Display device
1220 Input/output controller
1222 Communication interface
1224 Storage device
1230 ROM
1240 Input/output chip

1. A control device that controls a vehicle,
the control device comprising:
an information acquisition unit that acquires a plurality of pieces of information detected by a sensor installed in a traffic signal; and
a control unit that controls the vehicle using the plurality of pieces of information acquired by the information acquisition unit and a trained model.

2. The control device according to claim 1, wherein
the control unit controls the vehicle every billionth of a second using the plurality of pieces of information and the trained model.

3. The control device according to claim 1, wherein
the control unit controls the vehicle using the plurality of pieces of information detected by the sensor installed in the traffic signal and the trained model in a case where the vehicle enters an intersection at which the traffic signal is installed, and
controls the vehicle using a plurality of pieces of information detected by a sensor mounted on the vehicle and the trained model in a case where the vehicle travels a travel path other than the intersection.

4. The control device according to claim 3, wherein
the control unit controls the vehicle using the plurality of pieces of information detected by the sensor installed in the traffic signal and the trained model in a case where the vehicle enters the intersection and in a case where an output value of the trained model in a case where the plurality of pieces of information detected by the sensor installed in the traffic signal is input to the trained model matches an output value of the trained model in a case where the plurality of pieces of information detected by the sensor mounted on the vehicle is input to the trained model.

5. (canceled)

6. A signal control device comprising:
a first acquisition unit that acquires a traffic condition around an intersection from a sensor provided around the intersection;
a second acquisition unit that acquires a travel plan of an autonomous vehicle scheduled to pass through the intersection;
a determination unit that determines whether or not a delay in the travel plan of the autonomous vehicle occurs when the autonomous vehicle passes through the intersection on the basis of the traffic condition acquired by the first acquisition unit; and
a control unit that controls a traffic signal at the intersection so as to suppress the delay in a case where the determination unit determines that the delay occurs.

7. The signal control device according to claim 6, wherein in a case where the determination unit determines that the delay occurs, the control unit controls the traffic signal at the intersection such that the traffic signal at the intersection is maintained to be a green light while the autonomous vehicle passes through the intersection.

8. The signal control device according to claim 6, wherein the autonomous vehicle in which the control unit controls the traffic signal at the intersection so as to suppress the delay is the autonomous vehicle having a degree of urgency set in advance equal to or higher than a predetermined value.

9. The signal control device according to claim 6, further comprising: a cooperative control unit that controls each of traffic signals at a plurality of intersections through which the autonomous vehicle is scheduled to sequentially pass so that the delay is suppressed in a case where the determination unit determines that the delay occurs.

10. A traffic signal device provided at each intersection, the traffic signal device comprising:
the signal control device according to claim 6; and
the traffic signal.

11. A traffic signal system comprising:
the traffic signal device according to claim 10 provided at each of a plurality of intersections; and
a cooperative control device that controls each of traffic signals at the plurality of intersections through which the autonomous vehicle is scheduled to sequentially pass so that the delay is suppressed in a case where the determination unit of any of a plurality of traffic signal devices determines that the delay occurs.

12. (canceled)

13. An information notification device comprising:
an acquisition unit that acquires a traffic condition around an intersection from a sensor provided around the intersection;
a generation unit that generates notification information to an autonomous vehicle about to enter the intersection on the basis of the traffic condition acquired by the acquisition unit; and
a display control unit that displays the notification information generated by the generation unit on a display unit provided around the intersection as code information.

14. The information notification device according to claim 13, wherein the generation unit generates, as the notification information, information including a plurality of pieces of travel instruction information for instructing each of a plurality of autonomous vehicles about to enter the intersection to travel.

15. The information notification device according to claim 14, wherein the generation unit generates the travel instruction information in consideration of a traffic condition in a blind spot region that is a blind spot from the autonomous vehicle around the intersection.

16. The information notification device according to claim 13, wherein the display control unit displays a two-dimensional code on the display unit as the code information.

17. A traffic signal device provided at each intersection, the traffic signal device comprising:
the information notification device according to claim 13; and
a traffic signal.

18. (canceled)
